(19) United States
(12) Patent Application Publication
(10) Pub. No.: US 2026/0218905 A1
(43) Pub. Date: Jul. 30, 2026

(54) COMBUSTION SYSTEM HAVING A FUEL CELL TO PRODUCE BLUE HYDROGEN

(71) Applicant: GE INFRASTRUCTURE TECHNOLOGY LLC, Greenville, SC (US)

(72) Inventors: Dhinesh THANGANADAR, Bengaluru (IN); Murali Krishna KALAGA, Bengaluru (IN); Joel Meador HALL, Greenville, SC (US); Thomas Raymond FARRELL, Greenville, SC (US)

(21) Appl. No.: 19/143,231

(22) PCT Filed: Dec. 30, 2022
(86) PCT No.: PCT/US2022/054318

§ 371 Date: Jun. 25, 2025

(51) Int. Cl. F23R 3/28; C01B 3/12; F02C 7/08; F02C 7/22; H01M 8/04007; H01M 8/04082; H01M 8/04089; H01M 8/0662; H01M 8/14

(52) U.S. Cl. CPC F23R 3/28; C01B 3/12; F02C 7/08; F02C 7/22; H01M 8/04067; H01M 8/04097; H01M 8/04201; H01M 8/0662; C01B 2203/0283; C01B 2203/067; C01B 2203/84; H01M 2008/147

(57) ABSTRACT

A combustion system is provided. The combustion system includes a topping cycle. The combustion system further includes a fuel cell including an anode side, a cathode side, and an electrolyte. The anode side receives fuel via an anode inlet line and generates anode output products containing a first portion of hydrogen. The cathode side receives oxidants from a cathode inlet line. The combustion system further includes a separation system having a water gas shift reactor that produces a second portion of hydrogen from the anode output products. The topping cycle is fluidly coupled to the separation system such that the topping cycle receives the hydrogen produced from the anode output products.

### FIELD

The present disclosure relates generally to a combustion system having a fuel cell to decarbonize the system using blue hydrogen produced from the fuel cell. Particularly, the present disclosure relates to producing blue hydrogen using a fuel cell, which can be used in different application (such as a gas turbine).

### BACKGROUND

A gas turbine power plant such as a combined cycle power plant (CCPP) or combined cycle system (CCS) generally includes a gas turbine having a compressor section, a combustion section, a turbine section, a heat recovery steam generator (HRSG) that is disposed downstream from the turbine and at least one steam turbine in fluid communication with the HRSG. During operation, air enters the compressor via an inlet system and is progressively compressed as it is routed towards a compressor discharge or diffuser casing that at least partially surrounds the combustor(s) of the combustion section. At least a portion of the compressed air is mixed with a fuel and burned within a combustion chamber defined within the combustor(s), thereby generating high temperature and high-pressure combustion gases.

The combustion gases are routed along a hot gas path from the combustor through the turbine where they progressively expand as they flow across alternating stages of stationary vanes and rotatable turbine blades which are coupled to a rotor shaft. Energy is transferred from the combustion gases to the turbine blades, causing the rotor shaft to rotate. The rotational energy of the rotor shaft may be converted to electrical energy via a generator. The combustion gases exit the turbine as exhaust gas, and the exhaust gas enters the HRSG. Thermal energy from the exhaust gas is transferred to water flowing through one or more heat exchangers of the HRSG, thereby producing superheated or supercritical steam. The superheated steam is then routed into the steam turbine which may be used to generate additional electricity, thus enhancing overall power plant efficiency.

Turbomachine combustion systems usually burn hydrocarbon fuels and produce air polluting emissions such as oxides of nitrogen (NOx), carbon monoxide (CO), and carbon dioxide (CO₂). Regulatory requirements for low emissions from gas turbines are continually growing more stringent, and environmental agencies throughout the world are now requiring even lower rates of emissions of pollutants from both new and existing gas turbines. Alternate fuels, such as hydrogen, which produces less emissions when burned, can be used as a substitute (or in addition to) natural gas to reduce the production pollutants in the combustor. However, hydrogen is difficult to obtain and store.

As such, an improved system and method for operating a combined cycle system that produces less emissions are desired and would be appreciated in the art.

### BRIEF DESCRIPTION

Aspects and advantages of the combustion systems and methods in accordance with the present disclosure will be set forth in part in the following description, or may be obvious from the description, or may be learned through practice of the technology.

In accordance with one embodiment, a combustion system is provided. The combustion system includes a gas turbine having a compressor section, a combustion section, and a turbine section. The combustion system further includes a fuel cell including an anode side, a cathode side, and an electrolyte. The anode side receives fuel via an anode inlet line and generates anode output products. The cathode side receives oxidants from a cathode inlet line. The combustion system further includes a separation system having a water gas shift reactor that produces hydrogen from the anode output products. The combustion section of the gas turbine is fluidly coupled to the separation system such that the combustion section receives the hydrogen produced from the anode output products.

In accordance with another embodiment, a method of operating a combustion system is provided. The combustion system having a fuel cell with an anode side, a cathode side, and an electrolyte. The method includes supplying fuel to the anode side of the fuel cell with an anode inlet line. The method further includes supplying oxidants to the cathode side of the fuel cell with a cathode inlet line. The method further includes producing, with the fuel cell, anode output products containing a first portion of hydrogen. The method further includes providing the anode output products from the anode side to a separation system. The separation system includes a water gas shift reactor. The method further includes producing a second portion of hydrogen with from the anode output products with the water gas shift reactor. The method further includes removing, with the separation system, water and carbon dioxide from the anode output products. The method further includes providing the hydrogen to a combustion section of a gas turbine engine.

These and other features, aspects and advantages of the present combustion systems and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present combustion systems and methods, including the best mode of making and using the present systems and methods, directed to one of ordinary skill in the art, is set forth in the specification, which makes reference to the appended figures, in which:

FIG. 1 is a schematic illustration of a combustion system in accordance with embodiments of the present disclosure;

FIG. 2 is a schematic illustration of a combustion system in accordance with embodiments of the present disclosure;

FIG. 3 is a schematic illustration of a combustion system in accordance with embodiments of the present disclosure;

FIG. 4 is a schematic illustration of a combustion system in accordance with embodiments of the present disclosure; and

FIG. 5 is a flow diagram of a method of operating a combustion system in accordance with embodiments of the present disclosure.

### DETAILED DESCRIPTION

Reference now will be made in detail to embodiments of the present combustion systems and methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity.

The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counterclockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Here and throughout the specification and claims, range limitations are combined, and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “line” may refer to a fluid carrying conduit, such as a pipe, hose, tube, duct, or other fluid carrying conduit.

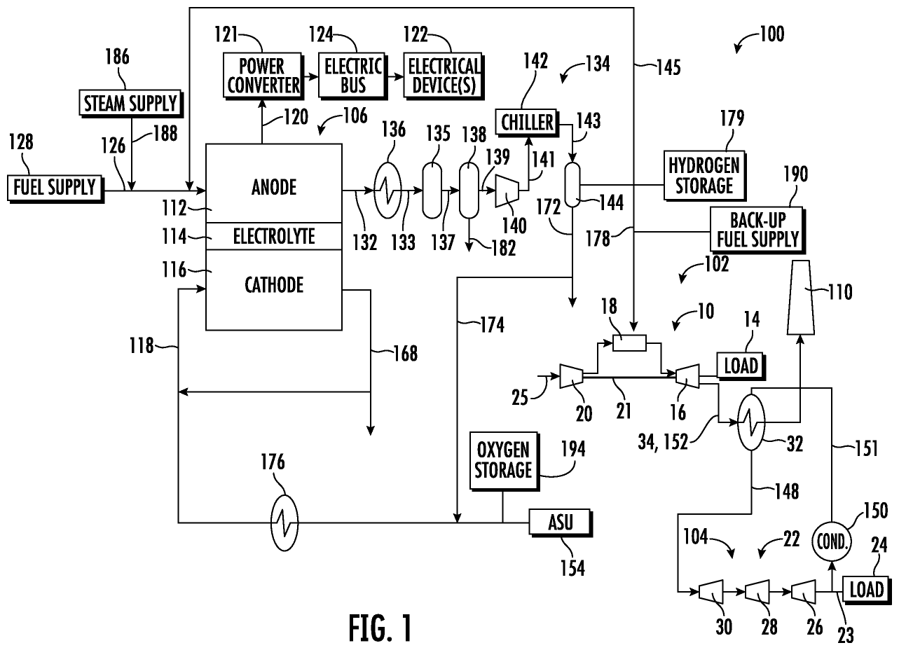

Referring now to the drawings, FIGS. 1 through 4 each illustrates a schematic diagram of one embodiment of a combustion system 100 (or combined cycle system, or a system for generating blue hydrogen) that includes a topping cycle 102 and a bottoming cycle 104. In the topping cycle 102, fuel is burnt to produce electrical or mechanical power, and, as a result, exhaust gas 34 is generated. In the bottoming cycle 104, the exhaust gas 34 from the topping cycle 102 may be then used to produce additional electrical or mechanical power. In various embodiments, the topping cycle 102 may be an internal combustion engine, an in industrial process in which fuel is burned, or others. In some embodiments, the bottoming cycle 104 may be a heat exchanger, a boiler, an economizer coil, a supercritical caron dioxide cycle, superheater, evaporator, pump, or others. In exemplary embodiments, as shown, the topping cycle 102 may be a gas turbine 10, and the bottoming cycle 104 may be a steam turbine system 22.

The combustion system 100 may include a gas turbine 10 for driving a first load 14. The first load 14 may, for instance, be an electrical generator for producing electrical power. The gas turbine 10 may include a turbine section 16, combustors or a combustion section 18, and a compressor section 20. The turbine section 16 and the compressor section 20 may be connected by one or more shafts 21.

In exemplary embodiments, as discussed in more detail below, the combustion system 100 may include a fuel cell 106 and a separation system 134. The fuel cell 106 may directly convert chemical energy stored in hydrocarbon fuel into electrical energy by means of an electrochemical reaction while generating output products. The output products from the fuel cell 106 may be delivered to the separation system 134, which may utilize the output products to generate a flow of hydrogen (which may be referred to as “blue hydrogen”) via a water gas shift (WGS) reactor 135. The hydrogen (H₂) from the separation system 134 may be supplied to the combustion section 18 for generating combustion gases.

In many embodiments, as shown, the combustion system 100 may include a hydrogen storage 179, which may store excess hydrogen produced by the fuel cell 100 and the water gas shift reactor 136. The hydrogen storage 179 may act as a buffer to bridge the dynamic mismatch between the hydrogen generation from the fuel cell 106 and the hydrogen demand from the gas turbine 10. In some embodiments, additional hydrogen from the hydrogen storage 179 may be exported for other processes (e.g., the excess hydrogen may be sold). The hydrogen storage 179 may be a storage tank, a geological storage (such as a salt cavern), or a pipeline (such as to other industrial processes).

For example, during operation of the gas turbine 10, a working fluid such as air 25 (e.g., ambient or atmospheric air) flows into the compressor section 20 where the air 25 is progressively compressed, thus providing compressed air to the combustor(s) of combustion section 18. In The compressed air is mixed with fuel (such as the hydrogen from the separation system 134) and burned within each combustor to produce combustion gases. The combustion gases flow through the hot gas path from the combustion section 18 into the turbine section 16, where energy (kinetic and/or thermal) is transferred from the combustion gases to the rotor blades, causing the one or more shafts 21 to rotate. The mechanical rotational energy may then be used to power the compressor section 20 and/or to generate electricity.

Heated exhaust gas 34 exiting the turbine section 16 may then be exhausted from the gas turbine 10 and routed through a heat recovery steam generator (HRSG) 32, where a heat transfer takes place between the exhaust gas 34 and the various components of the HRSG 32 to generate steam, which is provided to the steam turbine system 22. The exhaust gas 34 may exit the HRSG 32 and be routed to the atmosphere via an exhaust stack 110.

The combustion system 100 may also include the steam turbine system 22 for driving a second load 24. The second load 24 may also be an electrical generator for generating electrical power. However, both the first and second loads 14, 24 may be other types of loads capable of being driven by the gas turbine 10 and steam turbine system 22. In addition, although the gas turbine 10 and steam turbine system 22 may drive separate loads 14 and 24, as shown in the illustrated embodiment, the gas turbine 10 and steam turbine system 22 may also be utilized in tandem to drive a single load via a single shaft.

In the illustrated embodiment, the steam turbine system 22 may include a low pressure (LP) steam turbine 26, an intermediate pressure (IP) steam turbine 28, and a high pressure (HP) steam turbine 30. The low pressure (LP) steam turbine 26, the intermediate pressure (IP) steam turbine 28, the high pressure (HP) steam turbine 30, and the load 24 may each be disposed on one or more shafts 23 (such as a common shaft in some embodiments). In some embodiments (not shown), the outlet of the HP steam turbine 30 may be fluidly coupled to a reheater in the HRSG 32 for the steam to be superheated and subsequently provided to the IP steam turbine 28 (or directly to the LP steam turbine 26 in embodiments where the IP steam turbine 28 is not present).

In exemplary embodiments, the fuel cell 106 may include an anode side 112, a cathode side 116, and an electrolyte 114 (which may conduct electrically charged ions). The fuel cell 106 may directly convert chemical energy stored in hydrocarbon fuel into electrical energy by means of an electrochemical reaction.

Particularly, the cathode side 116 may receive oxidants (such as a flow of oxidants) from a cathode inlet line 118. The anode side 112 may receive fuel (such as methane or other hydrocarbon fuel) from an anode inlet line 126, which may be mixed with steam from the steam supply 186 (in order to maintain a desired steam to carbon ratio). The fuel in the anode side 112 and the oxidants in the cathode side 116 may electrochemically react with the electrolyte 114 within the fuel cell and generate a power output (e.g., a DC power output, which may be provided to a power converter 121), anode output products, and cathode output products. In exemplary embodiments, the fuel cell 106 may be a molten carbonate fuel cell (MCFC), such as an internal reforming MCFC and/or an external reforming MCFC. In such embodiments, the electrolyte 114 may be a molten carbonate salt mixture suspended in a porous, chemically inert, ceramic matrix of beta-alumina solid electrolyte (BASE). The MCFC may operate by passing a reactant fuel gas (e.g., natural gas such as methane or other hydrocarbon) through the anode side 112, while oxidizing gas is passed through the cathode side 116, which causes an electrochemical reaction across the electrolyte 114 that produces electricity.

As briefly mentioned above, the fuel cell 106 converts the anode fuel stream into electrical energy while moving the oxygen and carbon dioxide from the exhaust gas from the cathode side 116 to the anode side as carbonate ions. For example, a fuel cell power output 120 may be directed to a power converter 121 in order to change the DC current into AC current that can be effectively utilized by one or more subsystems. In particular, for the embodiment depicted, the power output 120 is provided from the power converter to one or more electric devices 122 via an electric bus 124. The electric bus 124 may be an electric bus dedicated to the combustion system 100, the gas turbine 10, the steam turbine system 22, an electric bus of the fuel cell 106, or others. The electric bus 124 is in electric communication with one or more additional electrical devices 122, which may be a power source, a power sink, or both. For example, the additional electrical devices 122 may be a power storage device (such as one or more batteries), an electric machine (an electric generator, an electric motor, or both). Alternatively, or additionally, the power output 120 may aid in driving the first load 14 and/or the second load 24. The combustion system 100 may generate a total power output (e.g., the summation of the first load 14, the second load 24, and the power output 120 of the fuel cell 106). In many embodiments, the power output 120 of the fuel cell 106 may be between about 10% and about 50% of the total power output of the combustion system 100. In other embodiments, the power output 120 of the fuel cell 106 may be between about 10% and about 30% of the total power output of the combustion system 100.

In many embodiments, the cathode side 116 may be fluidly coupled to one or more oxidant sources at least partially via a cathode inlet line 118. Particularly, the cathode side 116 may receive oxidants from the cathode inlet line 118. For example, the cathode inlet line 118 may be fluidly coupled to one or more of an air separation unit (ASU) 154 and/or or an air source 158. The cathode side 116 may be provided with a mixture of O₂ and CO₂. The liquid carbon dioxide separator 144 may supply the CO₂ for the cathode side 116, and the O₂ source for the cathode side 116 may be the ASU 154 or ambient air. The cathode side 116 may be provided with two moles of CO₂ is required for every 1 mole of O₂ consumed in the cathode side 116. In the embodiment shown in FIG. 1, the cathode side 116 may be fluidly coupled to an air separation unit (ASU) 154. The ASU 154 may separate air (such as atmospheric air in many embodiments) into its primary components, typically nitrogen and oxygen, and sometimes also argon and other rare inert gases. The ASU 154 may provide a flow of oxygen (O₂) to the cathode side 116 via the cathode inlet line 118. For example, the ASU 154 may provide a flow a cathode inlet stream containing high amounts of oxygen (e.g., much higher than atmospheric air), such as greater than about 85% oxygen, or such as greater than about 90% oxygen, or such as greater than about 95% oxygen, or such as 100% oxygen. For example, the cathode inlet line 118 may extend between the ASU 154 and an inlet of the cathode side 116.

In some embodiments, an oxygen storage 194 may be fluidly coupled to the ASU 154 and fluidly coupled to the cathode inlet line 118. For example, the oxygen storage 194 may store oxygen from the ASU 154 (e.g., excess oxygen or oxygen produced during non-operation of the system). The oxygen storage 194 may supply oxygen to the cathode side 116, via the cathode supply line 118, when the ASU 154 is down (e.g., not operating or non-operational) or during transient scenarios (e.g., when ASU 154 is being shut off and the air source 158 is being turned on).

Additionally, the oxygen storage 194 advantageously ensures that the operating limitations of the ASU 154 do not limit the oxygen demand of the fuel cell 106. For example, when the fuel cell 106 requires more oxygen than the ASU 154 can generate, the oxygen storage 194 may supply the additional required oxygen.

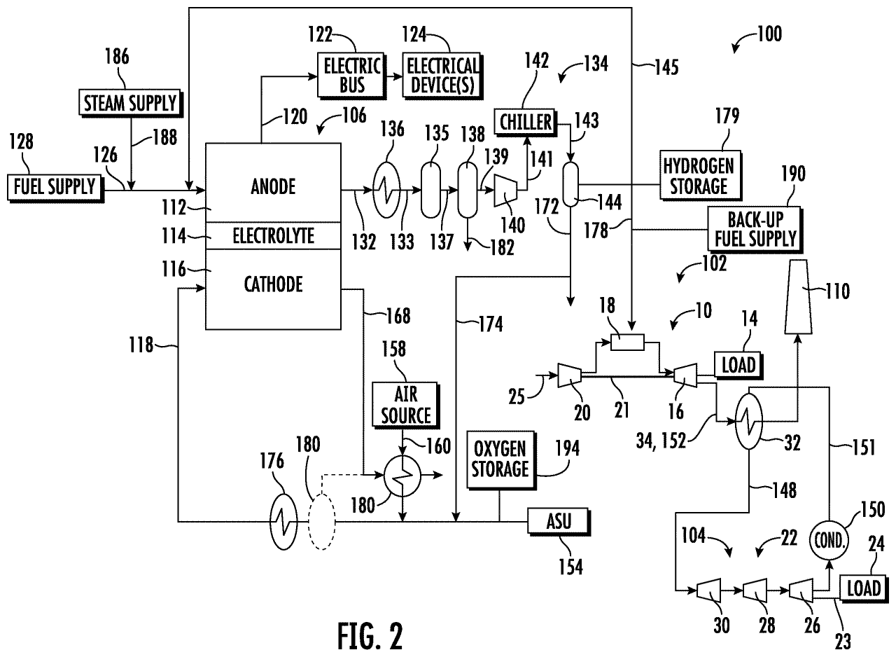

Additionally, or alternatively, as shown in FIG. 2, the cathode side 116 may be fluidly coupled to an air source 158 (such as the atmosphere or another air source) via an air inlet line 160. For example, the air inlet line 160 may extend between, and fluidly couple the air source 158 to the cathode inlet line 118. The air source 158 may provide atmospheric air (e.g., air containing about 78% nitrogen, about 21% oxygen, about 1% argon, and about 0.05% carbon dioxide). In some embodiments, the air source 158 may be a storage tank having atmospheric air contained therein. In other embodiments, the air source 158 may be a fan or blower fluidly coupled to the atmosphere and to the cathode inlet line 118, such that operation of the fan or blower provides atmospheric air to the cathode side 116. In yet still other embodiments (not shown), the oxygen may be supplied or generated from a co-located electrolyzer. In such embodiments, the products of the co-located electrolyzer are H₂ and O₂, and the O₂ may be provided to the cathode side 116.

In many embodiments, as shown in FIGS. 1 and 2, the combustion system 100 may include a back-up fuel supply 190 fluidly coupled to the combustor fuel supply 178. The back-up fuel supply 190 may supply fuel to the gas turbine 10 when the fuel cell 106 is non-operational or in a part load scenario.

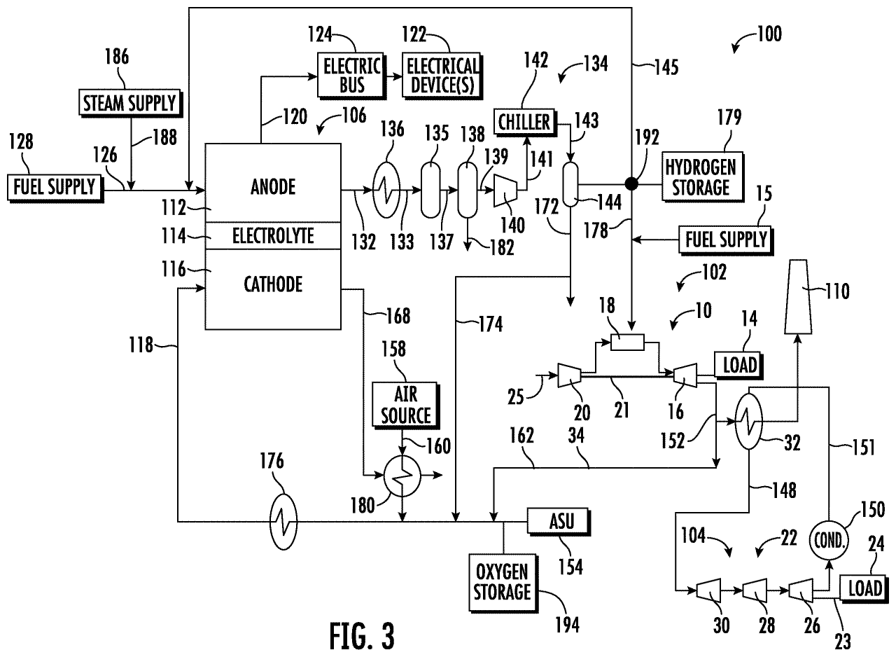

In alternative embodiments, as shown in FIG. 3, the cathode side 116 may be fluidly coupled to an outlet of the turbine section 16. For example, a branch line 162 may extend from a turbine outlet line 152. The branch line 162 may convey a portion of the exhaust gases to the cathode inlet line 118, where the exhaust gases will travel to the inlet of the cathode side 116. The exhaust gases may include nitrogen, carbon dioxide, oxygen, and water. In some embodiments, all of the exhaust gas 34 from the outlet of the turbine section 16 may be routed through the cathode side 116 of the fuel cell 106, which may remove a portion of CO₂ from the exhaust gas. For example, the fuel cell (which in exemplar embodiments is an MCFC) may operate by passing a reactant fuel gas (e.g., natural gas) through the anode side 112, while oxidizing gas (e.g., the exhaust gas which contains carbon dioxide) is passed through the cathode side 116, which causes an electrochemical reaction across the electrolyte 114 that consumes (or chemically converts) carbon dioxide and produces electricity. Particularly, up to about 85% of the carbon dioxide in the exhaust gases from the turbine section 16 may be removed (i.e., electrochemically converted) in the cathode side 116 of the fuel cell 106. In such embodiments, a combustor fuel supply 15 may supply a fuel to the combustors in the combustion section 18 in addition, or as an alternative, to the fuel supplied by the separation system 134. The combustor fuel supply 15 may supply a natural gas to the combustion section 18, such as a hydrocarbon fuel, which may include methane, propane, or others. In exemplary embodiments, the combustor fuel supply 15 may supply methane (CH₄) to the combustion section 18.

In various embodiments, the anode side 112 may receive a flow of fuel and steam (e.g., a fuel/steam mixture) via an anode inlet line 126. The fuel may be conveyed through the anode side 112. The anode inlet line 126 may fluidly couple the anode side 112 to an anode fuel supply 128. The amount of fuel supplied to the anode side 112 may be the sum of the fuel required to operate the fuel cell 106 and the fuel required to produce the hydrogen demand by the process (such as the topping cycle 102 or other industrial process using hydrogen) via in-situ steam methane reforming. In some embodiments, the anode fuel supply 128 may be the same as the combustor fuel supply 15, such that the same fuel is supplied to both the combustion section and the anode side of the fuel cell 106. In exemplary embodiments, the quantity of fuel supplied to the fuel cell 106 may be the sum of the fuel requirement of the fuel cell 106 and the hydrogen requirement of the gas turbine 10. In other embodiments, the anode fuel supply 128 and the combustor fuel supply 15 may be different. In many implementations, the anode fuel supply 128 may supply a natural gas (e.g., a hydrocarbon fuel) to the anode side 112 via the anode inlet line 126. The natural gas may include methane, propane, or others. In exemplary embodiments, the anode fuel supply 128 may supply methane (CH₄) to the anode side 112. In some embodiments (not shown), a fuel preheater, such as a heat exchanger, may be disposed in thermal communication on the anode inlet line 126 for heating the fuel prior to entrance into the anode side 112.

In exemplary embodiments, the combustion system 100 may include an anode steam supply 186 fluidly coupled to the anode inlet line 126 via an anode steam supply line 188. The anode steam supply line 188 may extend between, and fluidly couple, the anode steam supply 186 and the anode inlet line 126. The anode steam supply line 188 may provide a flow of steam to the anode inlet line 126 for use in the anode side 112 of the fuel cell 106. In various embodiments (not shown), the anode steam supply 186 may be fluidly coupled to the HRSG 32, such that the HRSG 32 supplies steam to both the steam turbine system 22 and the anode side 112 of the fuel cell 106. The anode steam may be generated by utilizing the heat from the heat exchanger 136, which may be augmented by supplying steam from the HRSG 32. In some embodiments, a fuel inlet heater may be disposed on the anode inlet line 126 upstream of the anode inlet to heat the fuel/steam entering the anode side 116.

In many embodiments, the combustion system 100 may include an anode outlet line 132 that is fluidly coupled to an outlet of the anode side 112, such that the anode outlet line 132 receives the output products from the anode side 112 after the electrochemical reaction within the fuel cell 106. In certain embodiments, the anode output products may include CO₂, CO, H₂ (e.g., “blue hydrogen”), water, and unutilized CH₄ (e.g., methane that was not utilized within the fuel cell 106 during the electrochemical reaction). The anode output products may be supplied to a separation system 134, which may chemically convert the carbon monoxide and water to carbon dioxide and hydrogen, and subsequently remove the water and liquified CO₂.

The separation system 134 may include, in a serial flow order (e.g., from upstream to downstream), a heat exchanger 136, a water gas shift reactor 135, a water flash separator 138, a compressor 140, a chiller 142, and a liquid carbon dioxide separator 144. The heat exchanger 136 may be thermally and fluidly coupled to the anode outlet line 132. For example, the anode outlet line 132 may extend between an outlet of the anode side 112 and the heat exchanger 136. The heat exchanger 136 may remove or add heat to the anode output products prior to entrance into the water flash separator 138. A water gas shift inlet line 133 may extend between, and fluidly couple, the heat exchanger 136 and the water gas shift reactor 135.

The water gas shift reactor 135 may produce hydrogen from the anode output products, and the combustion section 18 of the gas turbine 10 may be fluidly coupled to the separation system 134 such that the combustion section 18 receives the hydrogen produced from the anode output products. Particularly, the water gas shift reactor may convert carbon monoxide (CO) and water (H₂O) in the anode output products to carbon dioxide (CO₂) and hydrogen (H₂). As such, the WGS output products may include CO₂, H₂, H₂O, unutilized CO, and unutilized CH₄. For example, “unutilized CH₄” may be methane that is not consumed in the fuel cell 106, and similarly, “unutilized CO” may be carbon monoxide that is not consumed in the water gas shift reactor 135.

In some embodiments, as shown in FIG. 3, a hydrogen separator 192 may be included in the separation system 134. The hydrogen separator may be a membrane system or a pressure swing adsorption (PSA) system. The hydrogen separator 192 may separate hydrogen from the hydrogen rich stream after the water flash separator 144. The hydrogen separator 134 may be included in combustion systems requiring very high purity H₂., which advantageously facilitates about 100% carbon dioxide capture and/or negative emissions (e.g., over 100% carbon dioxide capture in some operational implementations). The separated anode output products (unconverted CO and unconverted CH₄ and CO₂) from the hydrogen separator may be re-circulated to the anode inlet (e.g., via the anode recirculation line 145). In embodiments having a hydrogen separator 192, the water gas shift reactor may be optional (e.g., not included).

A water flash inlet line 137 may extend between, and fluidly couple, the water gas shift reactor 135 and the water flash separator 138. The water flash separator 138 may remove any water from the WGS output products. For example, the water in the WGS output products may be cooled to a liquification temperature removed by the water flash separator 138. For example, the water flash separator 138 may include a water outlet line 182 that extends from the water flash separator 138 and conveys all the water removed from the WGS output products by the water flash separator 138.

In many embodiments, a compressor inlet line 139 may extend between, and fluidly couple, the water flash separator 138 and the compressor 140. The compressor 140 may pressurize the WGS output products and provide the pressurized WGS output products to a chiller 142 via a chiller inlet line 141. The chiller 142 may liquify the CO2 in the pressurized WGS output products by reducing the temperature of the pressurized WGS output products. Subsequently, the liquid CO₂ may be removed via the liquid carbon dioxide separator 144. For example, the chiller 142 may be fluidly coupled to the liquid carbon dioxide separator 144 via a connection line 143.

The liquid carbon dioxide separator 144 may include a liquid carbon dioxide outlet line 172, which may be in partial fluid communication with the cathode inlet line 118 (e.g., a portion of the liquid carbon dioxide may be supplied to the cathode inlet line 118). The liquid carbon dioxide outlet line 172 may extend from the liquid carbon dioxide separator 144. A branch line 174 may extend between, and fluidly couple, the liquid carbon dioxide outlet line 172 and the cathode inlet line 118, such that the liquid carbon dioxide, which is separated from the WGS output produces, is provided to the cathode side 116 for subsequent electrochemical conversion (e.g., the CO₂ may be converted within the fuel cell 106). Particularly, the liquid CO₂ may be reheated with a cathode input heat exchanger 176. The cathode input heat exchanger 176 may heat the oxidant (e.g., the oxygen, atmospheric air, and/or exhaust gases) and/or the liquid CO₂ (thereby vaporizing the liquid CO₂ into gaseous CO₂ prior to entrance into the cathode side 116).

A primary combustor fuel supply line 178 may extend from an outlet of the separation system 134 and the combustion section of the gas turbine, to provide the output products from the separation system 134 to the combustors in the combustion section 18 of the gas turbine 10. Particularly, the primary combustor fuel supply line 178 may extend from the liquid carbon dioxide separator 144 to the combustion section 18. The primary combustor fuel supply line 178 may supply a flow of fuel containing mostly hydrogen (e.g., greater than 50% hydrogen) to the combustion section 18. More specifically, the primary combustor fuel supply line may supply a flow of fuel containing between about 85% and about 99% hydrogen, between about 1% and about 5% methane, and carbon monoxide. In exemplary embodiments, the combustion section 18 may only receive fuel from the output products of the separation system 134, such that a dedicated fuel supply is not necessary.

In some embodiments, as shown in FIGS. 1 through 4, an anode recirculation line 145 may extend from the separation system 134 to the anode inlet line 126. Particularly, the anode recirculation line 145 may extend from an outlet of the separation system 134 to the anode inlet line 126. For example, the anode recirculation line 145 may extend from the primary combustor fuel supply line 178 to the anode inlet line 126 to reintroduce a portion of the anode output products (which have had the water and liquid carbon dioxide removed) into the anode side 112. For example, the anode recirculation line 145 may advantageously reintroduce any unconverted methane and/or any unconverted carbon monoxide back into the anode side 112 for electrochemical conversion. The anode recirculation line 145 may facilitate the load share between the fuel cell 106 and gas turbine 10. This would also facilitate starting the system and other transients where the hydrogen purity of the anode output products is poor. In which case, the storage tank 179 would supply the fuel to gas turbine 179 and the anode output products would be recirculated to the anode inlet to stabilize the process.

The HRSG 32 may generate steam with the heat from the exhaust gases exiting the turbine section 16, and the steam may be supplied to the steam turbine system 22. For example, a steam supply line 148 may extend from the HRSG 32 to the steam turbine system 22. Particularly, the steam supply line 148 may extend from the HRSG 32 to the HP steam turbine 30. The outlet of the HP steam turbine 30 may be fluidly coupled to an inlet of the IP steam turbine 28 (or to a reheater in the HRSG), and an outlet of the IP steam turbine 28 may be fluidly coupled to an inlet of the LP steam turbine 26. An outlet of the LP steam turbine may be fluidly coupled to a condenser 150 via a turbine outlet line 152. The condenser may convert the steam from the outlet of the LP steam turbine 26 to water, which may be provided back to the HRSG 32 via a condensate return line 151.

In many embodiments, the combustion system 100 may further include a cathode outlet line 168 that conveys the cathode output products from the cathode side 116. In some embodiments, as shown in FIG. 1, the cathode outlet line 168 may extend from, and fluidly couple, an outlet of the cathode side 116 to the cathode inlet line 118. In such embodiments, the cathode output products may be recirculated to the inlet of the cathode side 116 for further electrochemical conversion. As such, the non-reacted CO2 and O₂ are recirculated back into the fuel cell 106. In other words, the CO₂ is not released from the cycle, and as such, the fuel cell 106 may achieve near 100% carbon capture rate. A blow-down line 169 may be fluidly coupled to the ambient environment and to the cathode outlet line 168 for disposing of at least a portion of the cathode output products (e.g., the non-reacting species in the cathode output products may be disposed of, such as argon and nitrogen). The blow-down line 169 may prevent the accumulation of minor non-reacting species in the system such as argon, nitrogen, or impurities introduced by the ASU 154.

In other embodiments, as shown in FIGS. 2 and 3, the cathode outlet line 168 may extend between the cathode side 116 and an air preheater 180. The air preheater 180 may be disposed in thermal communication on the air inlet line 160. For example, the air preheater 180 may be a heat exchanger that transfers heat between the cathode output products in the cathode outlet line 168 and the air in the air inlet line 160. In some embodiments (not shown), the cathode output products may subsequently be provided to the cathode inlet line 118 for recirculation through the cathode side 116 after passing through the air preheater 180.

In various implementations, the combustion system 100 may include three operational modes, e.g., a first operational mode, a second operational mode, and a third operational mode.

In the first operational mode, the anode side 112 may receive methane fuel from the anode fuel supply 128, and the cathode side 116 may receive oxygen from the ASU 154 and a portion of liquid carbon dioxide from the carbon dioxide separator 144. The fuel cell 106 may generate a power output 120, cathode output products, and anode output products. In the first operational mode, as shown in FIG. 1, the cathode output products may be recirculated to the cathode inlet line 118. The anode output products, which include hydrogen, may be provided to the separation system 134. The water gas shift reactor 135 may receive the anode output products and produce additional hydrogen. Subsequently, the water and the carbon dioxide may be removed from the anode output products, thereby leaving hydrogen, unconverted methane, and unconverted carbon monoxide, which may be conveyed to the combustion section for burning via the primary combustor fuel supply line 178. In such embodiments, the combustors in the combustions section 18 may operate entirely from the fuel provided by the fuel cell 106 and the separation system 134, such that no other dedicated fuel supply is necessary for the combustion section 18.

In the second operational mode, the anode side 112 may receive methane fuel from the anode fuel supply 128, and the cathode side 116 may receive atmospheric air from the air source and a portion of liquid carbon dioxide from the carbon dioxide separator 144. The fuel cell 106 may generate a power output 120, cathode output products, and anode output products. In the second operational mode, as shown in FIG. 2, the cathode output products may provided to an air preheater 180 disposed on the air inlet line 160 for heating the atmospheric air provided to the cathode side 116. The anode output products, which include hydrogen, may be provided to the separation system 134. The water gas shift reactor 135 may receive the anode output products and produce additional hydrogen. Subsequently, the water and the carbon dioxide may be removed from the anode output products, thereby leaving hydrogen, unconverted methane, and unconverted carbon monoxide, which may be conveyed to the combustion section for burning via the primary combustor fuel supply line 178. In such embodiments, the combustors in the combustions section 18 may operate entirely from the fuel provided by the fuel cell 106 and the separation system 134, such that no other dedicated fuel supply is necessary for the combustion section 18.

In the third operational mode, the anode side 112 may receive methane fuel from the anode fuel supply 128, and the cathode side 116 may receive exhaust gases from the turbine section 16 of the gas turbine 10. The fuel cell 106 may generate a power output 120, cathode output products, and anode output products.

Additionally, the fuel cell 106 may convert carbon dioxide from the exhaust gases.

The anode output products, which included hydrogen, may be provided to the separation system 134. The water gas shift reactor 135 may receive the anode output products and produce additional hydrogen. Subsequently, the water and the carbon dioxide may be removed from the anode output products, thereby leaving hydrogen, unconverted methane, and unconverted carbon monoxide, which may be conveyed to the combustion section for burning via the primary combustor fuel supply line 178. In the third operational mode, the combustors in the combustions section 18 may receive methane from a combustor fuel supply 15, in addition or as an alternative, to the fuel from the separation system 134. In many embodiments, the system 100 may switch between the second operational mode and the third operational mode when the ASU 154 is unavailable (or non-operational).

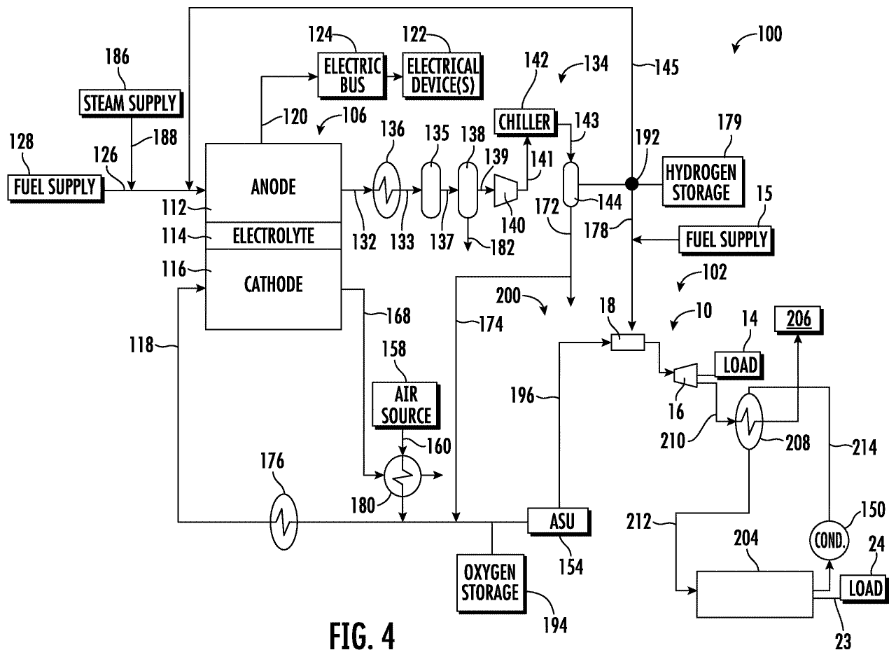

Referring now to FIG. 4, in some embodiments, the combustion system 100 may include a Graz cycle 200 having a topping cycle 202 and a bottoming cycle 204. In the topping cycle 202, fuel is burnt to produce electrical or mechanical power. In the bottoming cycle 204, from the output products from the topping cycle 202 may be used to produce additional power. In various embodiments, the topping cycle 202 may be an internal combustion engine, an in industrial process in which fuel is burned, or others. In some embodiments, the bottoming cycle 204 may be a heat exchanger, a boiler, an economizer coil, a supercritical caron dioxide cycle, superheater, evaporator, pump, or others. The topping cycle 202 may be coupled to a first load 14, and the bottoming cycle 204 may be coupled to a second load 24.

In exemplary embodiments, the topping cycle 202 may be a gas turbine 10 that does not include a compressor section. For example, the ASU 154 may be overdesigned to meet the demand of the fuel cell 106 and the gas turbine 10. Particularly, the gas turbine 10 may run in oxy-combustion mode where hydrogen is supplied to the combustion section 18 and the additional oxygen from ASU 154 is supplied to the gas turbine 10. An oxygen supply line 196 may extend between the ASU 154 directly to the combustion section 18. In some implementations, steam, nitrogen (N₂) or other inert gases, such as argon (Ar) may be used as a dilution gas to maintain the desired oxygen concentration at the combustor inlet.

Supplying the gas turbine with exclusively hydrogen and oxygen will eliminate nitrogen in the output products of the gas turbine 10, and only small amount of oxygen will be present in the output products of the gas turbine 10. In other words, when the gas turbine 10 is supplied with oxygen from the ASU 154, the gas turbine exhaust may be mainly water. The water may be supplied to a heat exchanger 208 via a heat exchanger inlet line 210 and subsequently supplied to one or more additional systems 206. The additional systems 206 may include a steam turbine, a recirculation line, and/or an exhaustion line. The heat exchanger 208 may generate steam for use in the bottoming cycle 204. For example, steam from the heat exchanger 208 may be supplied to the bottoming cycle 204 via a bottoming cycle inlet line 212 that extends between the heat exchanger and the bottoming cycle 204. A condenser 150 may be fluidly coupled to an outlet of the bottoming cycle 204, and the condensate may be supplied to the heat exchanger 208 via a heat exchanger return line 214 that extends between the condenser 150 and the heat exchanger 208.

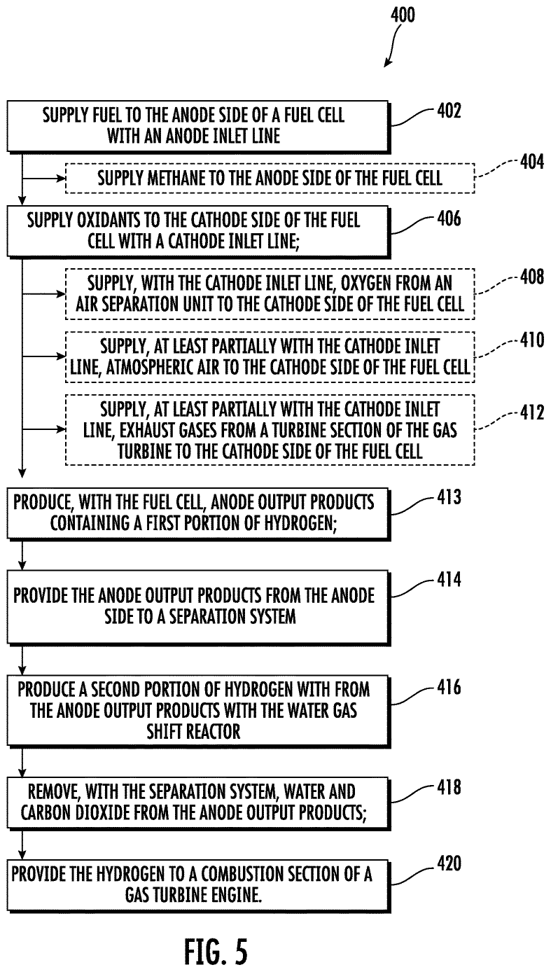

Referring now to FIG. 5, a flow diagram of one embodiment of a method 400 for operating a combustion system 100 is illustrated in accordance with aspects of the present subject matter. In general, the method 400 will be described herein with reference to the combustion system 100 described above with reference to FIGS. 1 through 4. However, it will be appreciated by those of ordinary skill in the art that the disclosed method 400 may generally be utilized with any suitable combustion system and/or may be utilized in connection with a system having any other suitable system configuration. In addition, although FIG. 5 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. As illustrated, dashed boxes in FIG. 5 may indicate optional steps of the method 400.

As shown, the method 400 may include at (402) supplying fuel to the anode side 112 of a fuel cell 106 with an anode inlet line 126. For example, supplying fuel to the anode side 112 of the fuel cell 106 may include conveying the fuel from an anode fuel supply 128 to an inlet of the anode side 112. In many embodiments, as shown, supplying at (402) may further include at (404) supplying methane (CH₄) to the anode side 112 of the fuel cell 106. Methane may advantageously produce the most desired output products from the fuel cell 106, which may be further processed and used in the gas turbine 10, while maintaining efficient operation of the fuel cell 106. In many embodiments, the method 400 may include providing steam from an anode steam supply 186, at least partially via a steam supply line 188, to the anode side 112 along with the fuel. For example, the steam supply line 188 may introduce a flow of steam into the anode inlet line 126 upstream of the anode side 112, such that a fuel and steam mixture is provided to the anode side 112, which may facilitate the electrochemical reaction within the fuel cell 106. In some embodiments (not shown), the steam may be provided from the HRSG 32. Steam and methane facilitate the steam methane reforming reaction to happen inside the anode side 112, which produces most of the hydrogen required for the electrochemical reaction of fuel cell 106 and also most of the hydrogen requirement of the gas turbine 10. Unconverted carbon monoxide will be reacted with water in the water gas shift reactor 135 to produce some additional hydrogen so that most of the carbon monoxide is utilized.

In exemplary implementations, as shown in FIG. 5, the method 400 may further include at (406) supplying oxidants to the cathode side 116 of the fuel cell 106 with a cathode inlet line 118. For example, in some embodiments, supplying oxidants at (406) may include at (408) supplying, with the cathode inlet line 118, oxygen from an air separation unit 154 to the cathode side 116 of the fuel cell. For example, the ASU 154 may provide a cathode inlet stream containing high amounts of oxygen (e.g., much higher than atmospheric air), such as greater than about 85% oxygen, or such as greater than about 90% oxygen, or such as greater than about 95% oxygen, or such as about 100% oxygen. In other embodiments, the oxygen may be supplied or generated from a co-located electrolyzer. In such embodiments, the products of the co-located electrolyzer are H₂ and O₂, and the O₂ may be provided to the cathode side 116 Additionally, or alternatively, supplying oxidants at (406) may further include at (410) supplying, at least partially with the cathode inlet line 118, atmospheric air to the cathode side 116 of the fuel cell 106. For example, in implementations, the oxidants supplied to the cathode side 116 may be solely (e.g., 100%) atmospheric air. In other implementations, the oxidants supplied to the cathode side 116 may be a mixture of atmospheric air and oxygen from the ASU 154. In yet still further embodiments, supplying oxidants at (406) may further include at (412) supplying, at least partially with the cathode inlet line 118, exhaust gases from a turbine section 16 of the gas turbine 10 to the cathode side 116 of the fuel cell 106.

For example, in some implementations, the oxidants supplied to the cathode side 116 may be solely (e.g., 100%) the exhaust gases. In other embodiments, the oxidants supplied to the cathode side 116 may be a mixture of exhaust gases, oxygen from the ASU 154, and/or atmospheric air.

The oxidants supplied to the cathode side 116, and the fuel supplied to the anode side 112, may travel through the fuel cell 106 on either side of the electrolyte 114. During this process, an electrochemical reaction may take place across the electrolyte 114 that generates a power output 120, anode output products, and cathode output products. The anode output products may include CO₂, CO, H₂, water, and unutilized CH₄ (e.g., methane that was not utilized within the fuel cell 106 during the electrochemical reaction).

The method 400 may include at (413) producing, with the fuel cell 106, anode output products containing a first portion of hydrogen. For example, hydrogen (which may be referred to as “blue hydrogen”) may be produced as a result of the electrochemical reaction within the fuel cell 106.

In exemplary implementations, the method 400 may include at (414) providing anode output products from the anode side 112 to a separation system 134. The separation system 134 may include a water gas shift reactor 135, a water flash separator 138, and a liquid carbon dioxide separator 144. In many implementations, the method 400 may include at (416) producing a second portion of hydrogen (H₂) from the anode output products with the water gas shift reactor 135. For example, the second portion of hydrogen may be produced as a result of the reaction within the water gas shift reactor 135. For example, the water gas shift reactor 135 may convert carbon monoxide and water vapor in the anode output products to carbon dioxide and hydrogen. The output products from the water gas shift reactor 135 may include CO₂, H₂, H₂O, unutilized CO, and unutilized CH₄. The second portion of hydrogen may be less than the first portion of hydrogen. That is, a majority of the hydrogen may be produced in the fuel cell 106, with a remainder being produced in the water gas shift reactor 135. In many implementations, the first portion of hydrogen produced by the fuel cell 106 may be between about 60% and about 95% of the total hydrogen produced in the combustion system 100, and the remaining hydrogen may be produced by the water gas shift reactor 135.

In many implementations, the anode output products may first be supplied to a heat exchanger 136 for heat transfer prior to entrance into the water gas shift reactor 135. The heat exchanger may remove heat (or add heat in some embodiments) to the anode output products to facilitate an efficient reaction within the water gas shift reactor 135. Particularly, the heat exchanger 136 may recover heat from an outlet of the fuel cell 106, which is around 650° C., and use the heat to produce steam that is provided to the cathode inlet stream.

The method 400 may further include at (418) removing, with the separation system 134, water and carbon dioxide from the anode output products. Particularly, the water and carbon dioxide may be removed after the water gas shift reaction, such that the water and the carbon dioxide are removed from the output products of the water gas shift reactor 135. Particularly, removing at (418) may further include removing water from the anode output products with a water flash separator 138. The water flash separator may be a vapor-liquid separator or other type of separator. Additionally, the method 400 may include compressing the anode output products with a compressor 140. For example, upon exiting the water flash separator 138, the anode output products may be provided to a compressor, which pressurizes the anode output products. In such embodiments, the method 400 may include cooling the anode output products with a chiller 142. As a result, gaseous carbon dioxide in the anode output products is condensed to liquid carbon dioxide. Particularly, the pressurized anode output products may be provided to the chiller 142 after exiting the compressor 140, and the chiller 142 may lower the temperature of the anode output products in order to condense the carbon dioxide. Subsequently, the method 400 may include removing the liquid carbon dioxide from the anode output products with a liquid carbon dioxide separator 144.

The liquid carbon dioxide separator 144 may remove all the liquid carbon dioxide from the anode output products and convey the liquid carbon dioxide with a liquid carbon dioxide outlet line 172. In many embodiments, the method 400 may further include providing the liquid carbon dioxide to the cathode inlet line 118. For example, the liquid carbon dioxide outlet line 172 may be fluidly coupled to the cathode inlet line 118 via a branch line 174. The liquid CO₂ may be reheated (and re-vaporized) with a cathode input heat exchanger 176. The cathode input heat exchanger 176 may heat the oxidant (e.g., the oxygen, atmospheric air, and/or exhaust gases) and/or the liquid CO₂ within the cathode inlet line 118 (thereby vaporizing the liquid CO₂ into gaseous CO₂ prior to entrance into the cathode side 116). Additionally, the cathode input heat exchanger 176 may maintain the temperature of the cathode input products (e.g., oxygen and/or ambient air) at between about 500° C. and about 650° C., or such as between about 600° C. and about 650° C.

In exemplary implementations, the method 400 may include at (420) providing the hydrogen to a combustion section 18 of a gas turbine 10. For example, this may include providing the first portion of hydrogen produced by the fuel cell 106 and the second portion of hydrogen produced by the water gas shift reactor 134 to the combustion section 18 of the gas turbine 10. Particularly, the primary combustor fuel supply line 178 may extend from the liquid carbon dioxide separator 144 to the combustion section 18 to provide the output products from the separation system 134 (e.g., the anode output products that have been modified by the separation system 134). The primary combustor fuel supply line 178 may supply a flow of fuel containing mostly hydrogen (e.g., greater than 50% hydrogen) to the combustion section 18. More specifically, the primary combustor fuel supply line may supply a flow of fuel containing between about 85% and about 95% hydrogen, between about 1% and about 5% methane, and carbon monoxide to the combustion section 18. The method 400 may include operating the combustors in the combustion section (e.g., firing one or more fuel nozzles) with the fuel provided by the separation system 134 via the primary combustor fuel supply line 178.

In exemplary embodiments, the fuel cell 106 and the separation system 134 (via the water gas shift reactor 135) may produce (or generate) a flow of blue hydrogen, which may be purified to a nearly pure (e.g., about 100%) hydrogen stream via the hydrogen separator 192. In exemplary embodiments, as shown in FIGS. 1-3, this blue hydrogen may be supplied to a combustion system (such as to the combustion section 18 via the combustor fuel supply line 178) or stored in the hydrogen storage 179. However, in other embodiments, the blue hydrogen may be used for other industrial applications.

In some embodiments, as shown in FIG. 1, the method may include providing, with a cathode outlet line 168, cathode output products from the cathode side to the cathode inlet line 118. In such embodiments, the cathode output products may be recirculated to the inlet of the cathode side 116 for further electrochemical conversion.

In other embodiments, as shown in FIG. 2, the method may include providing, with a cathode outlet line 168, cathode output products from the cathode side 116 to an air preheater 180. The air preheater 180 may be disposed on an air inlet line 160. Alternatively, as shown in phantom in FIG. 2, the air preheater 180 may be disposed on the cathode inlet line 118 immediately upstream of the cathode input heat exchanger 176. In such embodiments, the cathode output products may heat the oxidants coming from the ASU 154 and/or the carbon dioxide coming from the carbon dioxide separator 144. The cathode output products may be provided to the air preheater 180 disposed on the air inlet line 160 for heating the atmospheric air provided to the cathode side 116.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A combustion system comprising: a topping cycle; a fuel cell including an anode side, a cathode side, and an electrolyte, the anode side receiving fuel via an anode inlet line and generating anode output products containing a first portion of hydrogen, the cathode side receiving oxidants from a cathode inlet line; and a separation system having a water gas shift reactor that produces a second portion hydrogen from the anode output products, wherein the topping cycle is fluidly coupled to the separation system such that the topping cycle receives the hydrogen produced from the anode output products.

The combustion system as in any of the preceding clauses, wherein the cathode side receives oxidants from a cathode inlet line, and wherein the cathode inlet line is fluidly coupled to one or more of an air separation unit (ASU) or an air source.

The combustion system as in any of the preceding clauses, wherein a cathode outlet line extends from an outlet of the cathode side to the cathode inlet line.

The combustion system as in any of the preceding clauses, wherein the cathode inlet line is fluidly coupled to an air source via an air inlet line.

The combustion system as in any of the preceding clauses, wherein a cathode outlet line extends between the cathode side and an air preheater, and wherein the air preheater is disposed in thermal communication on the air inlet line.

The combustion system as in any of the preceding clauses, wherein an anode recirculation line extends from the separation system to the anode inlet line.

The combustion system as in any of the preceding clauses, wherein the separation system comprises water flash separator having a water outlet line and a liquid carbon dioxide separator having a liquid carbon dioxide outlet line, and wherein a branch line fluidly couples the cathode inlet line to the carbon dioxide outlet line of the liquid carbon dioxide separator.

The combustion system as in any of the preceding clauses, further comprising an anode steam supply fluidly coupled to the anode inlet line via an anode steam supply line.

The combustion system as in any of the preceding clauses, wherein the topping cycle is a gas turbine having a compressor section, a combustion section, and a turbine section, and wherein the combustion section further comprises a heat recovery steam generator (HRSG) that receives exhaust gases from the turbine section via a turbine outlet line, the HRSG generating steam for use in a bottoming cycle.

The combustion system as in any of the preceding clauses, wherein the separation system further comprises a hydrogen separator.

A method of operating a combustion system, the combustion system having a fuel cell with an anode side, a cathode side, and an electrolyte, the method comprising: supplying fuel to the anode side of the fuel cell with an anode inlet line; supplying oxidants to the cathode side of the fuel cell with a cathode inlet line; producing, with the fuel cell, anode output products containing a first portion of hydrogen; providing the anode output products from the anode side to a separation system, the separation system comprising a water gas shift reactor; producing a second portion of hydrogen with from the anode output products with the water gas shift reactor; removing, with the separation system, water and carbon dioxide from the anode output products; and providing the hydrogen to a combustion section of a gas turbine engine.

The method as in any of the preceding clauses, wherein supplying oxidants further comprises: supplying, with the cathode inlet line, oxygen from an air separation unit to the cathode side of the fuel cell.

The method as in any of the preceding clauses, wherein supplying oxidants further comprises: supplying, at least partially with the cathode inlet line, atmospheric air to the cathode side of the fuel cell.

The method as in any of the preceding clauses, wherein supplying oxidants further comprises: supplying, at least partially with the cathode inlet line, exhaust gases from a turbine section of the gas turbine to the cathode side of the fuel cell.

The method as in any of the preceding clauses, wherein supplying fuel to the anode side further comprises supplying methane to the anode side of the fuel cell.

The method as in any of the preceding clauses, wherein the removing step further comprises: removing water from the anode output products with a water flash separator; compressing the anode output products with a compressor; cooling the anode output products with a chiller, whereby gaseous carbon dioxide in the anode output products is condensed to liquid carbon dioxide; and removing the liquid carbon dioxide from the anode output products with a liquid carbon dioxide separator.

The method as in any of the preceding clauses, further comprising providing the liquid carbon dioxide to the cathode inlet line, the cathode inlet line fluidly coupled to the cathode side of the fuel cell.

The method as in any of the preceding clauses, further comprising providing, with a cathode outlet line, cathode output products from the cathode side to an air preheater, the air preheater disposed on an air inlet line.

The method as in any of the preceding clauses, further comprising providing, with a cathode outlet line, cathode output products from the cathode side to the cathode inlet line.

A blue hydrogen generation system comprising: a fuel cell including an anode side, a cathode side, and an electrolyte, the anode side receiving fuel via an anode inlet line and generating anode output products containing a first portion of hydrogen, the cathode side receiving oxidants from a cathode inlet line, the anode side receiving fuel from a fuel supply; and a separation system having a water gas shift reactor that produces a second portion hydrogen from the anode output products.

The blue hydrogen generation system as in any of the preceding clauses, wherein the cathode side receives oxidants from a cathode inlet line, and wherein the cathode inlet line is fluidly coupled to one or more of an air separation unit (ASU) or an air source.

The blue hydrogen generation system as in any of the preceding clauses, wherein a cathode outlet line extends from an outlet of the cathode side to the cathode inlet line.

The blue hydrogen generation system as in any of the preceding clauses, wherein the cathode inlet line is fluidly coupled to an air source via an air inlet line.

The blue hydrogen generation system as in any of the preceding clauses, wherein a cathode outlet line extends between the cathode side and an air preheater, and wherein the air preheater is disposed in thermal communication on the air inlet line.

The blue hydrogen generation system as in any of the preceding clauses, wherein an anode recirculation line extends from the separation system to the anode inlet line.

The blue hydrogen generation system as in any of the preceding clauses, wherein the separation system comprises water flash separator having a water outlet line and a liquid carbon dioxide separator having a liquid carbon dioxide outlet line, and wherein a branch line fluidly couples the cathode inlet line to the carbon dioxide outlet line of the liquid carbon dioxide separator.

The blue hydrogen generation system as in any of the preceding clauses, further comprising an anode steam supply fluidly coupled to the anode inlet line via an anode steam supply line.

The blue hydrogen generation system as in any of the preceding clauses, wherein the separation system further comprises a hydrogen separator.

What is claimed is:

1. A combustion system comprising:
a topping cycle;
a fuel cell including an anode side, a cathode side, and an electrolyte, the anode side receiving fuel via an anode inlet line and generating anode output products containing a first portion of hydrogen, the cathode side receiving oxidants from a cathode inlet line; and
a separation system having a water gas shift reactor that produces a second portion hydrogen from the anode output products, wherein the topping cycle is fluidly coupled to the separation system such that the topping cycle receives the hydrogen produced from the anode output products.

2. The combustion system as in claim 1, wherein the cathode side receives oxidants from a cathode inlet line, and wherein the cathode inlet line is fluidly coupled to one or more of an air separation unit (ASU) or an air source.

3. The combustion system as in claim 1, wherein a cathode outlet line extends from an outlet of the cathode side to the cathode inlet line.

4. The combustion system as in claim 1, wherein the cathode inlet line is fluidly coupled to an air source via an air inlet line.

5. The combustion system as in claim 1, wherein a cathode outlet line extends between the cathode side and an air preheater, and wherein the air preheater is disposed in thermal communication on the air inlet line.

6. The combustion system as in claim 1, wherein an anode recirculation line extends from the separation system to the anode inlet line.

7. The combustion system as in claim 1, wherein the separation system comprises water flash separator having a water outlet line and a liquid carbon dioxide separator having a liquid carbon dioxide outlet line, and wherein a branch line fluidly couples the cathode inlet line to the carbon dioxide outlet line of the liquid carbon dioxide separator.

8. The combustion system as in claim 1, further comprising an anode steam supply fluidly coupled to the anode inlet line via an anode steam supply line.

9. The combustion system as in claim 1, wherein the topping cycle is a gas turbine having a compressor section, a combustion section, and a turbine section, and wherein the combustion section further comprises a heat recovery steam generator (HRSG) that receives exhaust gases from the turbine section via a turbine outlet line, the HRSG generating steam for use in a bottoming cycle.

10. The combustion system as in claim 1, wherein the separation system further comprises a hydrogen separator.

11. A method of operating a combustion system, the combustion system having a fuel cell with an anode side, a cathode side, and an electrolyte, the method comprising:
supplying fuel to the anode side of the fuel cell with an anode inlet line;
supplying oxidants to the cathode side of the fuel cell with a cathode inlet line;
producing, with the fuel cell, anode output products containing a first portion of hydrogen;
providing the anode output products from the anode side to a separation system, the separation system comprising a water gas shift reactor;
producing a second portion of hydrogen with from the anode output products with the water gas shift reactor;
removing, with the separation system, water and carbon dioxide from the anode output products; and
providing the hydrogen to a combustion section of a gas turbine engine.

12. The method as in claim 11, wherein supplying oxidants further comprises:
supplying, with the cathode inlet line, oxygen from an air separation unit to the cathode side of the fuel cell.

13. The method as in claim 11, wherein supplying oxidants further comprises:
supplying, at least partially with the cathode inlet line, atmospheric air to the cathode side of the fuel cell.

14. The method as in claim 11, wherein supplying oxidants further comprises:
supplying, at least partially with the cathode inlet line, exhaust gases from a turbine section of the gas turbine to the cathode side of the fuel cell.

15. The method as in claim 11, wherein supplying fuel to the anode side further comprises supplying methane to the anode side of the fuel cell.

16. The method as in claim 11, wherein the removing step further comprises:
removing water from the anode output products with a water flash separator;
compressing the anode output products with a compressor;
cooling the anode output products with a chiller, whereby gaseous carbon dioxide in the anode output products is condensed to liquid carbon dioxide; and
removing the liquid carbon dioxide from the anode output products with a liquid carbon dioxide separator.

17. The method as in claim 16, further comprising providing the liquid carbon dioxide to the cathode inlet line, the cathode inlet line fluidly coupled to the cathode side of the fuel cell.

18. The method as in claim 11, further comprising providing, with a cathode outlet line, cathode output products from the cathode side to an air preheater, the air preheater disposed on an air inlet line.

19. The method as in claim 11, further comprising providing, with a cathode outlet line, cathode output products from the cathode side to the cathode inlet line.

20. A blue hydrogen generation system comprising:
a fuel cell including an anode side, a cathode side, and an electrolyte, the anode side receiving fuel via an anode inlet line and generating anode output products containing a first portion of hydrogen, the cathode side receiving oxidants from a cathode inlet line, the anode side receiving fuel from a fuel supply; and
a separation system having a water gas shift reactor that produces a second portion hydrogen from the anode output products.

21. The blue hydrogen generation system as in claim 20, wherein the cathode side receives oxidants from a cathode inlet line, and wherein the cathode inlet line is fluidly coupled to one or more of an air separation unit (ASU) or an air source.

22. The blue hydrogen generation system as in claim 20, wherein a cathode outlet line extends from an outlet of the cathode side to the cathode inlet line.

23. The blue hydrogen generation system as in claim 20, wherein the cathode inlet line is fluidly coupled to an air source via an air inlet line.

24. The blue hydrogen generation system as in claim 20, wherein a cathode outlet line extends between the cathode side and an air preheater, and wherein the air preheater is disposed in thermal communication on the air inlet line.

25. The blue hydrogen generation system as in claim 20, wherein an anode recirculation line extends from the separation system to the anode inlet line.

26. The blue hydrogen generation system as in claim 20, wherein the separation system comprises water flash separator having a water outlet line and a liquid carbon dioxide separator having a liquid carbon dioxide outlet line, and wherein a branch line fluidly couples the cathode inlet line to the carbon dioxide outlet line of the liquid carbon dioxide separator.

27. The blue hydrogen generation system as in claim 20, further comprising an anode steam supply fluidly coupled to the anode inlet line via an anode steam supply line.

28. The blue hydrogen generation system as in claim 20, wherein the separation system further comprises a hydrogen separator.
